(19) United States
(12) Patent Application Publication
(10) Pub. No.: US 2026/0260516 A1
(43) Pub. Date: Sep. 3, 2026

(54) METHOD AND DEVICE FOR DETECTING A MOVING BODY NEAR A STRUCTURE

(71) Applicant: SENS OF LIFE, CLERMONT L'HERAULT (FR)

(72) Inventor: Hubert LAGRANGE, CLERMONT L'HERAULT (FR)

(73) Assignee: SENS OF LIFE, CLERMONT L'HERAULT (FR)

(21) Appl. No.: 19/158,040

(22) PCT Filed: Feb. 27, 2024
(86) PCT No.: PCT/EP2024/054870

§ 371 Date: Aug. 19, 2025

(30) Foreign Application Priority Data
Feb. 28, 2023 (FR) FR2301837

(51) Int. Cl. G06V 40/20; G06T 7/223; G06T 7/254; G06V 10/82; G06V 20/40

(52) U.S. Cl. CPC G06V 40/20; G06T 7/223; G06T 7/254; G06V 10/82; G06V 20/49; G06T 2207/10016; G06T 2207/20084; G06T 2207/20224

(57) ABSTRACT

The invention relates to a method (100) for detecting a moving body close to a structure, which comprises:
a step (105) of capturing a video stream;
a step (110) of decomposing the video stream into a sequence of images;
a step (125) of subtracting a first image and a second image from the sequence;
a step (150) of detecting a movement which is representative of the presence of a moving body;
a step (155) of defining coordinates which are representative of a search window of the moving body;
a step (170) of constituting a sequence of truncated images by selecting, in the initial sequence of images, an area of the images which are restricted to the search window; and
a step (175) of processing, by means of a trained neural network, the sequence of truncated images.

### TECHNICAL FIELD OF THE INVENTION

The present invention relates to a method and a device for detecting a moving body near a structure. It applies, in particular, to the field of the intelligent management of parks generating energy from wind power.

### STATE OF THE ART

The approaches described in this section are approaches that could be pursued, but not necessarily approaches that have been developed or pursued previously. Consequently, unless otherwise indicated, it should not be assumed that any of the approaches described in this section constitute a prior art solely due to its inclusion in this section.

The interaction of animals with certain infrastructures can be a source of danger for these animals. For example, some species of birds and bats can be killed by the movements of wind turbine blades.

Conversely, some species can damage existing structures or deteriorate their use. For example, photovoltaic panels have their performance deteriorated by the droppings of birds that use these structures as resting places.

Several patents describe different solutions for driving these animals away from structures they are likely to interact with, so as to limit the risks caused by these interactions. Among these patents, the use of sounds is frequently described. These solutions consist of distributing sound emitters around and on the equipment to be protected. For example, U.S. Pat. No. 9,125,394B2 and patent application US20170127664A1 describe specific ultrasound emission systems (whistles, emitters mounted on bars outside the structure).

However, these approaches share the main drawback of having a limited ability to detect the presence of animals.

To remedy this drawback, some systems utilise devices based on artificial intelligence, such as the systems described in patent application CN111127516.

Such systems utilise a stacking image by image of an activation map (or features map) produced by a neural network.

The feature maps result from various types of computer processing making the results difficult to interpret and validate by a human operator. This difficulty leads to an often poor design resulting in a lower ability to detect the presence of a moving body.

The scientific publication by Yoshihashi R. et al., “Bird detection and species classification with time-lapse images around a wind farm: Dataset construction and evaluation”, which discloses the development of a database intended to be used in the development of an automatic bird detection system for wind farms, is known. In this document, the step of defining coordinates around a bird is a manual step and takes place before the step detecting the bird.

The technical and sales brochure by Rioperez A. et al., “DTBird: A self-working system to reduce bird mortality in wind farms”, which discloses a bird detection system for a wind farm whose image processing method is not described, is also known.

Neural networks such as “R-CNN” (acronym for “Region Based Convolutional Neural Networks”) and “YOLO” (acronym for “You Only Look Once”), are also known. These include algorithms commonly used in the field of region-based object detection. These systems have convolutional layers responsible for extracting the characteristics necessary for detection, such as the shape, colour and/or texture of an object.

However, these extracted characteristics are not sufficient to detect a moving body in certain cases. For example, when a body, at distance, has a spot shape when moving towards or away from the camera, such as a flying bird, a drone or a plane, the body is not detected.

### SUMMARY OF THE INVENTION

The purpose of the present invention is to detect a moving body by means of sequential analysis of the same area in a sequence of images, referred to as a “search window”, initially determined as a function of the detection, in an image, of a shape representative of a moving body.

### BRIEF DESCRIPTION OF THE FIGURES

Other advantages, aims and particular features of the invention will become apparent from the non-limiting description that follows of at least one particular embodiment of the method and device that are the subjects of the present invention, with reference to drawings included in an appendix, wherein:

FIG. 1 represents, schematically and in the form of a logic diagram, a particular series of steps of the method that is the subject of the present invention; and

FIG. 2 represents, schematically, a particular embodiment of the device that is the subject of the present invention.

### DESCRIPTION OF THE INVENTION

The present invention aims to remedy all or part of these drawbacks.

To this end, according to a first aspect, the present invention envisages a method for detecting a moving body close to a structure, which method comprises:
a step of capturing a video stream representative of the environment around the structure;
a step of decomposing the video stream, by a computational device, into an initial sequence of at least two successive images;
a step of subtracting, by a computational device, a first image and a second image from the initial sequence;
a step of detecting, by a computational device, a movement which is representative of the presence of a moving body as a function of the subtraction performed;
a step of defining, by a computational device, coordinates which are representative of a search window of the moving body as a function of the coordinates of the movement detected;
a step of constituting, by a computational device, a sequence of truncated images by selecting, in the initial sequence of images, an area of the images which are restricted to the search window; and
a step of processing, by means of a trained neural network, the sequence of truncated images in order to recognise a moving body in the sequence of images.

Thanks to these provisions, the volume of data transmitted to the neural network is limited to a usable portion, of a plurality of images, in which a shape that could be that of a moving body has already been detected.

These provisions make it possible to reduce the number of calls to the neural network per unit of time. This results in several advantages:
a reduction in the costs of computational platforms;
a possibility of pooling the processing of several cameras on the same platform; and
a possibility of utilising very deep neural networks (six or more layers of neurons).

In addition, the sequence of truncated images constituted during the constitution step is a search window. This search window is similar to a “virtual volume”, the base of which is the area defined in the initial image around a bird, during the automatic detection step, the volume extending from the base in the following images, provided a movement is detected. In other words, the area defined in the initial image, when a movement is detected, is repeated in the following images to form this search window, provided a movement is detected. The definition frame has the same coordinates in the images that follow the initial image, so that this area is not analysed multiple times.

In some embodiments, the method that is the subject of the present invention also comprises, when the structure comprises a moving portion, a step of emitting a command stopping the moving portion when a moving body is detected.

In some embodiments, the moving body is an animal.

In some optional embodiments, the method that is the subject of the present invention comprises:
a step of the time integration, by a computational device, of results from the processing step;
a step of detecting, in the integrated results, a pattern representative of a risk of collision between the moving body and the moving portion.

In some embodiments, the step of emitting a command stopping the moving portion is performed as a function of the pattern detected.

These embodiments make it possible to determine whether a moving body is moving towards or away from the structure, for example.

In some optional embodiments, the method that is the subject of the present invention comprises a step of emitting an audible and/or visible warning as a function of the pattern detected.

These embodiments make it possible to graduate the level of the response to the presence of an animal, initially by startling it, by emitting a sound, and then by stopping the moving portion if that is not sufficient.

In some optional embodiments, the method that is the subject of the present invention comprises, after the subtraction step, a step of thresholding applied to the result of the subtraction step.

In some optional embodiments, the method that is the subject of the present invention comprises, after the thresholding step, a step of erosion applied to the result of the thresholding step.

In some optional embodiments, the method that is the subject of the present invention comprises, after the erosion step, a step of dilation applied to the result of the erosion step.

These embodiments make it possible to eliminate the small, insignificant movements considered noise.

In some optional embodiments, the method that is the subject of the present invention comprises, after the dilation step, a step of segmentation applied to the result of the dilation step.

In some optional embodiments, the network is a convolutional neural network.

According to a second aspect, the present invention envisages a device for detecting a moving body close to a structure, which comprises:
a means for capturing a video stream representative of the environment around the structure;
a means for decomposing the video stream into an initial sequence of at least two successive images;
a means for subtracting a first image and a second image from the initial sequence;
a means for detecting a movement which is representative of the presence of a moving body as a function of the subtraction performed;
a means for defining coordinates which are representative of a search window of the moving body as a function of the coordinates of the movement detected;
a means for constituting a sequence of truncated images by selecting, in the initial sequence of images, an area of the images which are restricted to the search window; and
a means for processing, by means of a trained neural network, the sequence of truncated images in order to recognise a moving body in the sequence of images.

In some embodiments, the method that is the subject of the present invention also comprises, when the structure comprises a moving portion, a means for emitting a command stopping the moving portion when a moving body is detected.

The device that is the subject of the present invention has the same advantages as the method that is the subject of the present invention. Embodiments equivalent to those of the method that is the subject of the present invention can also be utilised.

### DETAILED DESCRIPTION

The present description is given in a non-limiting way, in which each characteristic of an embodiment can be combined with any other characteristic of any other embodiment in an advantageous way.

Note that the figures are not to scale.

As can be seen from reading the present description, different inventive concepts can be implemented by one or more methods or devices described below, several examples of which are given here. The actions or steps carried out in the framework of realising the method or device can be ordered in any appropriate way. As a consequence, it is possible to construct embodiments in which the actions or steps are carried out in a different order from the one shown, which can include executing some acts simultaneously, even if they are presented as sequential acts in the embodiments shown.

The expression “and/or”, as it is used in the present document and in the claims, must be understood as meaning “one or other, or both” of the elements thus connected, i.e. elements that are present conjunctively in some cases and disjunctively in other cases. The multiple elements listed with “and/or” must be interpreted in the same way, i.e. “one or more” of the elements thus connected. Other elements can possibly be present, other than the elements specifically identified by the clause “and/or”, whether or not they are linked to these specifically identified elements. Therefore, as a non-limiting example, a reference to “A and/or B”, when it is used in conjunction with open-ended language such as “comprising”, can refer, in one embodiment, to A only (possibly including elements other than B); in another embodiment, to B only (possibly including elements other than A); in yet another embodiment, to A and B (possibly including other elements); etc.

As used here in the present description and in the claims, the expression “at least one”, in reference to a list of one or more elements, must be understood as meaning at least one element chosen from among one or more elements in the list of elements, but not necessarily including at least one of each element specifically listed in the list of elements and not excluding any combination of elements in the list of elements. This definition also allows the optional presence of elements other than the elements specifically identified in the list of elements to which the expression “at least one” refers, whether or not they are linked to these specifically identified elements. Therefore, as a non-limiting example, “at least one of A and B” (or, equivalently, “at least one of A or B” or, equivalently, “at least one of A and/or B”), can refer, in one embodiment, to at least one, possibly including more than one, A, with no B present (and possibly including elements other than B); in another embodiment, to at least one, possibly including more than one, B, with no A present (and possibly including elements other than A); in yet another embodiment, to at least one, possibly including more than one, A and at least one, possibly including more than one, B (and possibly including other elements); etc.

In the claims, and also in the description below, all the transitive expressions such as “comprising”, “including”, “bearing”, “having”, “containing”, “involving”, “made of”, “formed of” and others, must be understood as being open, i.e. meaning including, but not limited to. Only the transitive expressions “consisting of” and “consisting essentially of” must be understood as closed or semi-closed expressions, respectively.

The term “structure” refers to any physical element of the environment, which can be a human construction, a natural element or flora. Such a structure is, for example, a building, a field, a river or a hill.

The term “structure comprising a moving portion” refers to any immoveable structure which comprises a moving portion that can be actuated. Such a structure is, for example, a wind turbine.

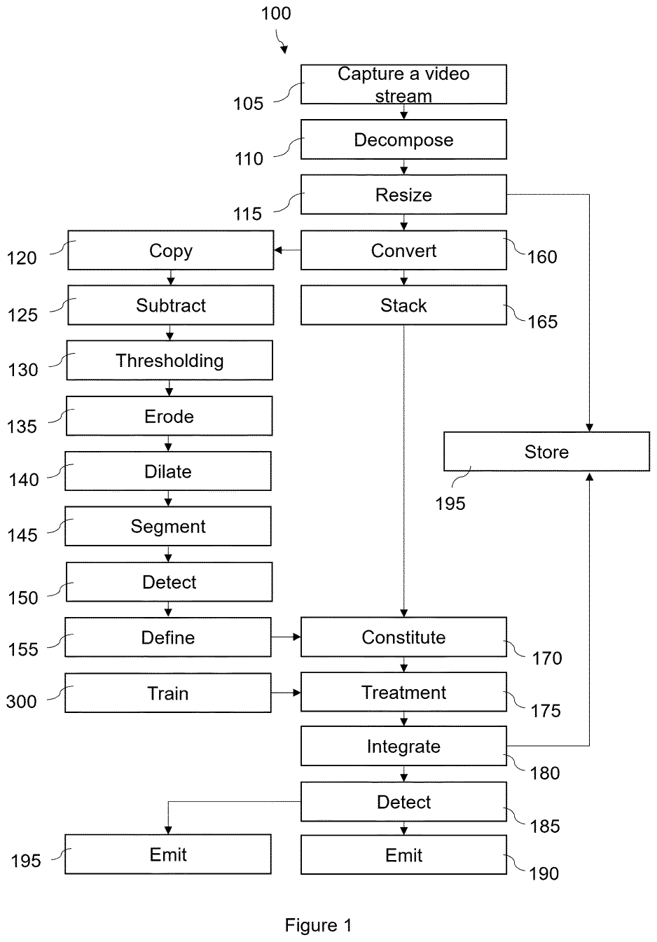

FIG. 1, which is not to scale, shows a schematic view of an embodiment of the method 100 that is the subject of the present invention. This method 100 for detecting a moving body close to a structure comprises:
a step 105 of capturing a video stream representative of the environment around the structure;
a step 110 of decomposing the video stream, by a computational device, into an initial sequence of at least two successive images;
a step 125 of subtracting, by a computational device, a first image and a second image from the initial sequence;
a step 150 of detecting, by a computational device, a movement which is representative of the presence of a moving body as a function of the subtraction performed;
a step 155 of defining, by a computational device, coordinates which are representative of a search window of the moving body as a function of the coordinates of the movement detected;
a step 170 of constituting, by a computational device, a sequence of truncated images by selecting, in the initial sequence of images, an area of the images which are restricted to the search window; and
a step 175 of processing, by means of a trained neural network, the sequence of truncated images in order to recognise a moving body in the sequence of images.

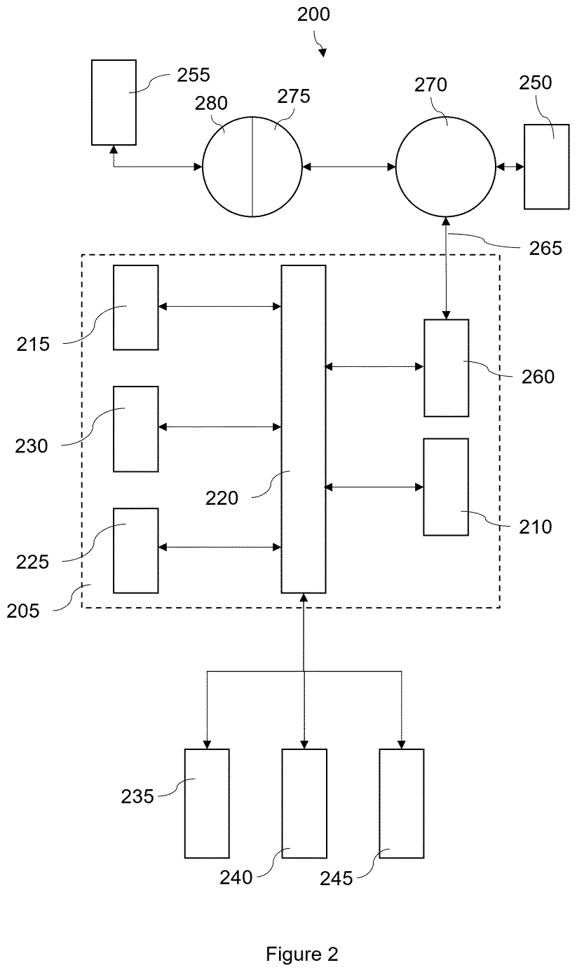

The capture step 105 is performed, for example, by an input device 240 as described with regard to FIG. 2. Such an input device 240 is, for example, a video camera operating in the visible or infrared spectrum.

The decomposition step 110 is performed, for example, by implementing a set of computer instructions, forming a computer program, executed by a computational device, such as a processor 210 as described with regard to FIG. 2.

During this decomposition step 110, the video stream captured during the capture step 105 is decomposed into a sequence of separate images, all or part of which is retained. In some preferred variants, each image is retained, improving the precision of the analysis performed.

In certain variants, the method 100 that is the subject of the present invention, as shown in FIG. 1, comprises a step (not shown) of selectively retaining images output from the decomposition step 110 according to a frequency determined (for example, one in two images).

In certain variants, the method 100 that is the subject of the present invention, as shown in FIG. 1, comprises a step 115 of resizing the images retained.

The resizing step 115 is performed, for example, by implementing a set of computer instructions, forming a computer program, executed by a computational device, such as a processor 210 as described with regard to FIG. 2.

The dimensions of the images resized in this way can be predefined or determined by a user, via a graphic interface type of configuration interface or an API type of application interface. The images obtained during the decomposition step 110 or resizing step 115 can be utilised during a storage step 195, described below.

In certain variants, the method 100 that is the subject of the present invention, as shown in FIG. 1, comprises a step 160 of converting the images retained or resized to grey-scale.

The conversion step 160 is performed, for example, by implementing a set of computer instructions, forming a computer program, executed by a computational device, such as a processor 210 as described with regard to FIG. 2.

During this conversion step 160, an image processing algorithm is, for example, utilised to convert colour images into grey-scale images.

In certain variants, the method 100 that is the subject of the present invention, as shown in FIG. 1, comprises a step 120 of copying the images retained, resized and/or converted to grey-scale.

The copying step 120 is performed, for example, by implementing a set of computer instructions, forming a computer program, executed by a computational device, such as a processor 210 as described with regard to FIG. 2.

During this copying step 120, all or part of the images retained, resized and/or converted to grey-scale are copied into a memory 225 of a computer system 205, as described with regard to FIG. 2.

The subtraction step 125 is performed, for example, by implementing a set of computer instructions, forming a computer program, executed by a computational device, such as a processor 210 as described with regard to FIG. 2.

During this subtraction step 125, a digital subtraction, pixel by pixel, defined by the coordinates of the abscissa, “x”, and ordinate, “y”, is performed so as to produce an image corresponding to an intensity difference between the two images.

The images selected by this subtraction step 125 are preferably two immediately successive images in the captured image stream.

In certain variants, the method 100 that is the subject of the present invention, as shown in FIG. 1, comprises a step 130 of thresholding on the result of the subtraction step 125.

The thresholding step 130 is performed, for example, by implementing a set of computer instructions, forming a computer program, executed by a computational device, such as a processor 210 as described with regard to FIG. 2.

During this thresholding step 130, a difference validity limit value, also known as the “thresholding value”, is applied to the result of the subtraction step 125. The thresholding value between the two subtracted images is utilised to nullify the differences considered insignificant. The values of the pixels of the result of the subtraction step 125 that are less than the thresholding value are set to 0; otherwise, they are set to 1. Consequently, the result of the thresholding step 125 will be a binary image consisting of pixel values 0 and 1.

The validity limit value can be predefined by a user, via a graphic interface type of configuration interface or an API type of application interface.

In certain variants, the method 100 that is the subject of the present invention, as shown in FIG. 1, comprises a step 135 of erosion on the result of the thresholding step 130.

The erosion step 135 is performed, for example, by implementing a set of computer instructions, forming a computer program, executed by a computational device, such as a processor 210 as described with regard to FIG. 2.

During this erosion step 135, all the pixels where the defining element centred on this pixel touch the exterior of the structure are sought. In other words, all the particles less than or equal to the size of the defining element, also known as the “erosion kernel”, are set to zero. The result is a cropped image.

In certain variants, the method 100 that is the subject of the present invention, as shown in FIG. 1, comprises a step 140 of dilation on the result of the erosion step 135.

The dilation step 140 is performed, for example, by implementing a set of computer instructions, forming a computer program, executed by a computational device, such as a processor 210 as described with regard to FIG. 2.

During this dilation step 140, a defining element is moved over each pixel of the image to see whether the defining element intersects the structure of interest. The result is a structure that is larger than the original structure. Depending on the size of the defining element, some particles can be connected and some holes disappear.

In certain variants, the method 100 that is the subject of the present invention, as shown in FIG. 1, comprises a step 145 of segmentation on the result of the dilation step 140.

The segmentation step 145 is performed, for example, by implementing a set of computer instructions, forming a computer program, executed by a computational device, such as a processor 210 as described with regard to FIG. 2.

During this segmentation step 145, an algorithm for identifying structures of interest in the image, also known as connected component analysis, connected component labelling, blob extraction or region labelling, is utilised. This algorithm utilises an approach for identifying connected components. Each individual connected component, which is a group of connected pixels, is grouped or labelled as a blob. A blob is therefore a region formed of a set of pixels connected spatially. Connected component analysis is therefore an algorithmic application of graph theory used to determine the connectivity of regions resembling “blobs” in a binary image. The result is presented in the form of a labelled image, each label corresponding to a region.

The detection step 150 is performed, for example, by implementing a set of computer instructions, forming a computer program, executed by a computational device, such as a processor 210 as described with regard to FIG. 2.

This detection step 150 corresponds, for example, to performing an algorithm which, on the basis of the result of the segmentation step 145, detects the presence of a shape likely to a moving body. This detection can be performed based on a value of confidence in the segmentation performed, for example. Criteria for the similarity of shapes can be predefined or determined by a user, via a configuration interface such as a graphic user interface, or via an application interface such as an API.

The definition step 155 is performed, for example, by implementing a set of computer instructions, forming a computer program, executed by a computational device, such as a processor 210 as described with regard to FIG. 2.

During the definition step 155, a centroid of coordinates of the abscissa, “xc”, and ordinate, “yc”, of a moving body is defined.

This definition step 155 corresponds, for example, to performing an algorithm which, according to the dimensions of the shape detected during the detection step 150, determines coordinates for forming a search window. A search window results, for example, from the partitioning of the initial image into squares of 120×120 pixels (or other dimensions suitable for the use). In other words, a search window can be a sub-image, corresponding to a truncated image of 120×120 pixels in which the centroid of the moving body is located. If at least one shape likely to a moving body is detected in one of these squares, this square is selected to be analysed by the neural network. This approach avoids having the same area to be analysed being sent several times if several shapes likely to a moving body are detected very close to each other.

In certain variants, the method 100 that is the subject of the present invention, as shown in FIG. 1, comprises, in parallel with the copying step 120, a step 165 of stacking images output from the decomposition step 110, resizing step 115 or conversion step 160.

The stacking step 165 is performed, for example, by implementing a set of computer instructions, forming a computer program, executed by a computational device, such as a processor 210 as described with regard to FIG. 2.

During the stacking step 165, a memory 225 of a computer system 205, as described with regard to FIG. 2, is for example utilised to store and index, in order of capture, the images stacked in this way.

A stacked image is the result of preserving the darkest pixels during a pixel-by-pixel of two grey-scale images, which are the previous stacked image from the previous iteration and the current image resulting from the conversion step 160.

The constitution step 170 is performed, for example, by implementing a set of computer instructions, forming a computer program, executed by a computational device, such as a processor 210 as described with regard to FIG. 2.

During this constitution step 170, the search window defined during the step 155 is applied to a sequence of captured images, coming from the decomposition step 110 or from an optional prior step. This application corresponds to a truncation of the initial image to obtain an image with smaller dimensions around an area of interest corresponding to the area in which a suspect shape has been detected during the detection step 150. The search windows are trimmed from the stacked image defined in step 155. The search window containing the given centroid of coordinates of the abscissa, “xc”, and ordinate, “yc”, is defined during the step 155. The search window is then cropped in the corresponding stacked image.

At the end of the constitution step 170, a sequence of images truncated from the stacked image is obtained. In other words, the search window reframed from the stacked image is introduced on input into the convolutional neural network. This sequence of truncated images serves as input for processing by a model trained by machine learning.

As can be understood, in some variants, the stream of truncated images thus utilised corresponds to a stream of colour or grey-scale images.

The processing step 175 is performed, for example, by implementing a set of computer instructions, forming a computer program, executed by a computational device, such as a processor 210 as described with regard to FIG. 2.

During this processing step 175, the sequence of truncated images is supplied to a model trained by machine learning to provide a prediction (or a “class”) relating to the presence or absence of a moving body in the captured video stream. Such a prediction is performed per image, preferably. For example, such a prediction can be relative to the presence of several moving bodies per image at different positions in the image.

In some preferred variants, The trained model corresponds to the result of machine learning performed by a convolutional neural network.

In certain variants, the method 100 that is the subject of the present invention, as shown in FIG. 1, comprises a step 180 of the time integration of the processing performed.

The integration step 180 is performed, for example, by implementing a set of computer instructions, forming a computer program, executed by a computational device, such as a processor 210 as described with regard to FIG. 2.

During this integration step 180, a series of results, organised according to an execution timestamp, is accumulated. Such an integration corresponds, for example, to a series of predictions of classes, corresponding for example to a series of successive detections of shapes representative of a moving body close to the structure.

In some variants, the result of this integration step is supplied to a storage step 195.

In certain variants, the method 100 that is the subject of the present invention, as shown in FIG. 1, comprises a step 195 of storage upon detection.

The storage step 195 is performed, for example, by implementing a set of computer instructions, forming a computer program, executed by a computational device, such as a processor 210 as described with regard to FIG. 2 associated with a memory 225.

This storage step 195 makes it possible to obtain qualitative and quantitative traceability of the detection and the stoppages of the moving portion, by visual inspection for example.

In some embodiments, the method 100 that is the subject of the present invention, as shown in FIG. 1, also comprises, when the structure comprises a moving portion, a step 190 of emitting a command stopping the moving portion when a moving body is detected.

In certain variants, the method 100 that is the subject of the present invention, as shown in FIG. 1, comprises a step 190 of emitting a command stopping the moving portion.

The step 190 of emitting a stop command is performed, for example, by implementing a set of computer instructions, forming a computer program, executed by a computational device, such as a processor 210 as described with regard to FIG. 2 associated with a communication interface 260 for wired or wireless communication with the structure. The precise nature of this command depends on the signals expected by the moving part. This command can be analog or digital.

In some embodiments, the moving body is an animal.

A moving body can be any element that may enter into contact with a moving part. Such a moving body is, for example, an animal or an object. Preferably, the moving body is a bird or a bat.

In certain variants, the method 100 that is the subject of the present invention, as shown in FIG. 1, comprises a step 195 of emitting an audible and/or visible warning when a moving body is detected.

Such an audible warning is emitted, for example, by a loudspeaker located near the structure.

Such a visual warning is emitted, for example, by a flashing lamp located near the structure.

The emission of an audible warning and/or a stop command can be sequential and determined according to the distance of the moving body and/or the direction of the moving body's movement. For example, if the moving body is at a distance greater than a predefined limit distance, an audible warning is emitted, whereas if the moving body is at a distance less than this limit distance, a stop command is emitted.

In certain variants, the method 100 that is the subject of the present invention, as shown in FIG. 1, comprises a pattern detection step 185.

The detection step 185 is performed, for example, by implementing a set of computer instructions, forming a computer program, executed by a computational device, such as a processor 210 as described with regard to FIG. 2.

During this detection step 185, a pattern representative of a movement of a moving body is detected, such as a distance, a speed or a movement coming towards or going away from the structure. The processing can vary depending on the pattern detected.

In this way, as can be understood, the method 100 that is the subject of the present invention can comprise:
a step 180 of the time integration, by a computational device, of results from the processing step;
a step 185 of detecting, in the integrated results, a pattern representative of a risk of collision between the moving body and the moving portion.

In some embodiments, the step 190 of emitting a command stopping the moving portion is performed as a function of the pattern detected.

In some embodiments, the network is a convolutional neural network.

In some variants, the method 100 that is the subject of the present invention comprises a step 300 of training a neural network.

This training step 300 implements, for example, a set of computer instructions executed by a computational device, such as a processor 210 as described with regard to FIG. 2.

To perform this training, a set of training data is assembled, such a set comprising a plurality of sequences of images, corresponding to the truncated images utilised by the trained model, associated to a predefined class (“detection of a moving body”, “non-detection of a moving body”, for example).

An example of such a set of training data is a set of images (120×120 pixels, grey-scale, compressed in JPG format) stored in two files. One contains almost 50,000 images of birds in flight, especially birds of prey, corresponding to a positive class of detection of the moving body. The other contains almost 50,000 images of other moving objects (wind turbine blades, airplane, drone, clouds, insects, vegetation, etc.) corresponding to a negative class of detection of the moving body. This set of training data is supplied to a machine learning architecture, of a convolutional neural network type for example.

Such a convolutional neural network has, for example, five successive layers of artificial neurons.

In some variants, such a convolutional neural network can comprise five convolutional layers, followed by maximum pooling, batch normalisation and dropout layers, and dense layers for the classification.

The result of this training step 300 is the provision of a trained model, able to assign a class to a sequence of images.

FIG. 2 shows, schematically, a particular embodiment of the device 200 for detecting a moving body close to a structure, which device comprises:
a means 240 for capturing a video stream representative of the environment around the structure;
a means 210 for decomposing the video stream into an initial sequence of at least two successive images;
a means 210 for subtracting a first image and a second image from the initial sequence;
a means 210 for detecting a movement which is representative of the presence of a moving body as a function of the subtraction performed;
a means 210 for defining coordinates which are representative of a search window of the moving body as a function of the coordinates of the movement detected;
a means 210 for constituting a sequence of truncated images by selecting, in the initial sequence of images, an area of the images which are restricted to the search window; and
a means 210 for processing, by means of a trained neural network, the sequence of truncated images in order to recognise a moving body in the sequence of images.

In some variants, the device 200 that is the subject of the present invention also comprises, when the structure comprises a moving portion, a means 260 for emitting a command stopping the moving portion when a moving body is detected.

Implementation variants of the device 200 are described with regard to FIG. 1. Such means are also described below.

In general, FIG. 2, which is not to scale, shows a block diagram which illustrates an example of a computer system with which an embodiment can be implemented. In the example in FIG. 2, a computer system 205 and instructions for the implementation of the disclosed technologies in the hardware, software, or a combination of hardware and software, are represented schematically, for example in the form of blocks and circles, at the same level of detail commonly used by people with ordinary skill in the art to which this disclosure relates, to provide information about the architecture of computers and the implementations of computer systems.

The computer 205 comprises an input/output (referred to as “I/O”) subsystem 220, which can comprise a bus and/or one or more other communication mechanisms for communicating information and/or instructions between the components of the computer system 205 over electronic signal paths. The input/output subsystem 220 can comprise an input/output controller, a memory controller and at least one input/output port. The electronic signal paths are represented schematically in the drawings, for example in the form of lines with unidirectional or bidirectional arrows.

At least one processor 210, or computational device, is coupled with the I/O subsystem 220 for processing the information and instructions. The processor 210 can comprise, for example, a microprocessor, a general-purpose microcontroller and/or a special-purpose microprocessor such as an integrated system, a graphics processing unit (GPU), a digital signal processor or an ARM processor. The processor 210 can comprise an integrated arithmetic logic unit (ALU) or can be coupled with a separate ALU.

The computer system 205 can comprise one or more memories 225, such as a main memory, which is coupled with the I/O subsystem 220 for the electronic digital storage of data and instructions to be executed by the processor 210. The memory 225 can comprise a volatile memory such as various forms of random-access memory (RAM) or any other dynamic storage device. The memory 225 can also be used to store temporary variables or other intermediate information during the execution of the instructions to be executed by the processor 210. Such instructions, when they are stored in a non-transitory computer-readable storage medium 210, can transform the computer system 205 into a special-purpose machine customised to perform the operations specified in the instructions.

The computer system 205 also comprises a non-volatile memory such as a read-only memory (ROM) 230 or another static storage device coupled with the I/O subsystem 220 to store information and instructions for the processor 210. The ROM 230 can comprise various forms of programmable ROM (PROM) such as erasable PROM (EPROM) or electrically erasable PROM (EEPROM). A persistent storage device 215 can comprise various forms of non-volatile random-access memory (NVRAM), such as a FLASH memory, or a solid-state storage, a magnetic disk or optical disk such as a CD-ROM or DVD-ROM, and can be coupled with the I/O subsystem 220 to store information and instructions. The memory 215 is an example of a non-transitory computer-readable medium that can be used for storing instructions and data which, when they are executed by the processor 210, cause the execution of computer-implemented methods implemented for executing the techniques of the present document.

The instructions in the memory 225, the ROM 230 or the storage 215 can comprise one or more sets of instructions which are organised into modules, methods, objects, functions, routines or calls. The instructions can be organised as one or more computer programs, operating system services or application programs, including mobile applications. The instructions can comprise an operating system and/or system software, one or more libraries to handle multimedia, programming or other functions; instructions or data protocol stacks for implementing TCP/IP, HTTP or other communication protocols; file format processing instructions to analyse or render files encrypted by using HTML, XML, JPEG, MPEG or PNG; user interface instructions to render or interpret commands for a graphic user interface (referred to as “GUI”), a command line interface or a text-based user interface; application software such as an office system, internet access applications, design and manufacturing applications, graphic applications, audio applications, software engineering applications, educational applications, games, or miscellaneous applications. The instructions can utilise a web server, a web application server, or a web client. The instructions can be organised in the form of a presentation layer, an application layer and a data storage layer such as a relational database system using a structured query language (SQL) or no SQL, an object store, a graphic database, a flat file system or any other data storage.

The computer system 205 cab be coupled via the I/O subsystem 220 with at least one output device 235. In an embodiment, the output device 235 is a digital computer screen. Display examples that can be used in various embodiments comprise a touch screen, a light emitting diode (LED) display, a liquid-crystal display (LCD) or an electronic paper display. The computer system 205 can comprise one or more other types of output devices 235, as a replacement for or in addition to a display device. Examples of other output devices 235 comprise printers, ticket printers, plotters, projectors, sound cards or video cards, loudspeakers, buzzers, piezoelectric devices or other audible devices, lamps or LED or LCD indicators, haptic devices, actuators or servos.

At least one input device 240 is coupled with the I/O subsystem 220 for communicating signals, data, selections of commands or gestures to the processor 210. Examples of input devices 240 comprise touch screens, microphones, digital still and video cameras, alphanumeric and other keys, keyboards, graphic tablets, image scanners, joysticks, clocks, switches, buttons, dials, sliders.

Another type of input device is a control device 245, which can perform a cursor command or other automated command functions such as navigation in a graphic interface on a display screen, as an alternative to or in addition to input functions. The control device 245 can be a touchpad, mouse, trackball, cursor direction keys for communicating direction information and command selections to the processor 210 and controlling the cursor's movement on the screen 235. The input device can have at least two degrees of freedom in two axes, a first axis (e.g. x) and a second axis (e.g. y), which allows the device to specify positions in a plane. Another type of input device is a wired, wireless or optical control device, such as a joystick, pointer, console, steering wheel, pedal, gear shift mechanism or any other type of control device. An input device 240 can include a combination of several different input devices, such as a video camera and a depth sensor.

In another embodiment, the computer system 205 can comprise an internet of things (referred to as “IoT”) device in which one or more output devices 235, input device 240 and control device 245 are omitted. Or, in such an embodiment, the input device 240 can comprise one or more cameras, movement detectors, thermometers, microphones, seismic detectors, other sensors or detectors, measuring devices, or coders, and the output device 235 can comprise a special-purpose display such as a single-line LED or LCD display, one or more indicators, a display panel, a counter, a valve, a solenoid, an actuator or a servomotor.

The output device 235 can comprise hardware, software, microprograms and interfaces for generating position report packets, notifications, pulse or heartbeat signals, or other transmissions of recurrent data that specify a position of the computer system 205, alone or in combination with other data specific to the application, directed towards the host 250 or the server 255.

The computer system 205 can implement the techniques described in this document by using a customised hard-wired logic, at least an ASIC (for “application-specific integrated circuit”) or an FPGA (for “field-programmable gate array”), a microprogram and/or program instructions or logic which, when they are loaded and used or executed in combination with the computer system, induce or program the computer system to operate as a special-purpose machine. According to an embodiment, the techniques described here are executed by the computer system 205 in response to the processor 210, which executes at least one sequence of at least one instruction contained in the main memory 225. These instructions can be read in the main memory 225 from another storage medium, such as the memory 215. Execution of the sequences of instructions contained in the main memory 225 leads the processor 210 to execute the steps of the process described in this document. In other embodiments, hard-wired circuits can be used instead of or in combination with software instructions.

The term “storage medium”, as used in this document, means any non-transitory medium that stores data and or instructions enabling a machine to operate in a specific way. These storage media can comprise non-volatile media and/or volatile media. The non-volatile media comprise, for example, optical or magnetic disks, such as the memory 215. The volatile media comprise dynamic memory, such as the memory 225. Common forms of storage media comprise, for example, a hard disk, solid-state player, flash player, magnetic data storage medium, any optical or physical data storage medium, memory chip, etc.

The storage media are distinct from the transmission media, but can be used together with them. The transmission media take part in transferring information between the storage media. For example, the transmission media comprise coaxial cables, copper wires and optical fibres, including the wires that form a bus of the I/O subsystem 220. The transmission media can also take the form of acoustic or light waves, such as those generated during the communication of data by radio and infrared waves.

Various forms of media can be involved in the transport of at least one sequence of at least one instruction to the processor 210 for execution. For example, the instructions can initially be transported on a magnetic disk or a solid-state player of a remote computer. The remote computer can load the instructions into its dynamic memory and send the instructions over a communications link such as a coaxial or optical fibre cable or a telephone line using a modem. A modem or a local router to the computer system 205 can receive the data over the communications link and converts the data into a format that can be read by the computer system 205. For example, a receiver such as a radio antenna or an infrared detector can receive the data transported in a wireless or optical signal and a suitable circuit can supply the data to the I/O subsystem 220, for example by placing the data on a bus. The I/O subsystem 220 transports the data to the memory 225, from which the processor 210 retrieves and executes the instructions. The instructions received by the memory 225 can possibly be stored on the memory 215 before or after execution by the processor 210.

The computer system 205 can comprise a communication interface 260 coupled with a bus 220. The communication interface 260 provides a two-way data communication coupling to the network link(s) 265 that are directly or indirectly connected to at least one communication network such as a network 270 or a public or private cloud on the Internet. For example, the communication interface 260 can be an Ethernet network interface, an integrated services digital network (ISDN) card, a cable modem, a satellite modem or a modem to provide a data communication connection to a corresponding type of communication line, for example an Ethernet cable, a metallic cable of any type, an optical fibre line or a telephone line. The network 270 largely represents a local area network (“LAN”), wide area network (“WAN”), campus network, internet network, or any combination of these. The communication interface 260 can comprise a LAN card to provide a data communication connection to a compatible LAN, or a cellular radio-telephone interface which is cabled for sending or receiving cellular data according to the cellular radio-telephone wireless network standards, or a radio satellite interface which is cabled for sending or receiving digital data according to satellite wireless network standards. In any implementation of this type, the communication interface 260 sends and receives electrical, electromagnetic or optical signals over signal paths that transport digital data streams representing various types of information.

The network link 265 typically provides an electrical, electromagnetic or optical data communication directly or through at least one network to other data devices, using, for example, satellite, cellular, Wi-Fi or BLUETOOTH technology. For example, the network link 265 can provide a connection over a network 270 to a host computer 250.

In addition, the network link 265 can provide a connection through the network 270 or to other computer devices via interconnection devices and/or computers that are operated by an internet service provider (ISP) 275. The ISP 275 provides data communication services by means of a global packet data communication network represented by the Internet 280. A server computer 255 can be coupled to the Internet 280. The server 255 largely represents any computer, datacentre, virtual machine or virtual computer instance with or without a hypervisor, or a computer executing a containerised program system such as DOCKER or KUBERNETES. The server 255 can represent an electronic digital service which is implemented using more than one computer or instance, and which is accessed and used by sending Web service requests, uniform resource locator (“URL”) strings with parameters in HTTP (acronym for “Hypertext Transfer Protocol”) payloads, API (acronym for “Application Programming Interface”) calls, application service calls or other service calls. The computer system 205 and the server 255 can form elements of a distributed computer system which comprises other computers, a processing cluster, a server farm or another organisation of computers that cooperate to perform tasks or execute applications or services. The server 255 can comprise one or more sets of instructions which are organised in the form of modules, methods, objects, functions, routines or calls. The instructions can be organised as one or more computer programs, operating system services or application programs, including mobile applications. The instructions can comprise an operating system and/or system software, one or more libraries to handle multimedia, programming or other functions; instructions or data protocol stacks for implementing TCP/IP (acronym for “Transmission Control Protocol/Internet Protocol”), HTTP or other communication protocols; file format processing instructions to analyse or render files encrypted by using HTML (acronym for “Hypertext Markup Language”), XML (acronym for “Extensible Markup Language”), JPEG (acronym for “Joint Photographic Experts Group”), MPEG (acronym for “Moving Picture Experts Group”) or PNG (acronym for “Portable Networks Graphic”); user interface instructions to render or interpret commands for a graphic user interface (“GUI”), a command line interface or a text-based user interface; application software such as an office system, internet access applications, design and manufacturing applications, graphic applications, audio applications, software engineering applications, educational applications, games, or miscellaneous applications. The server 255 can comprise a web application server which hosts a presentation layer, an application layer and a data storage layer such as a relational database system using a structured query language (SQL) or no SQL, an object store, a graphic database, a flat file system or any other data storage.

The computer system 205 can send messages and receive data and instructions, including program code, by means of network(s), the network link 265 and the communication interface 260. In the Internet example, a server 255 can send a code requested for an application program by means of the Internet 280, ISP 275, local network 270 and communication interface 260. The code received can be executed by the processor 210 as it is received, and/or stored in the memory 215, or in another non-volatile memory for subsequent execution.

The execution of instructions as described in this section can implement a process in the form of an instance of a computer program being executed and constituted of program code and its current activity. Depending in the operating system (“OS”), a process can be constituted of several execution threads that execute instructions simultaneously. In this context, a computer program is a passive collection of instructions, whereas a process can be the actual execution of these instructions. Several processes can be associated with the same program; for example the opening of several instances of the same program often means that more than one process is being executed. Multitasking can be implemented to allow several processes to share the processor 210. Although each processor 210 or kernel of the processor executes a single task at a time, the computer system 205 can be programmed to implement multitasking to allow each processor to switch between tasks that are being executed without having to wait for each task to finish. In an embodiment, switching can be carried out when the tasks perform input/output operations, when a task indicates that it can be switched, or on hardware interrupts. Time-sharing can be implemented to allow a rapid response to the interactive applications of the users by rapidly performing context switches to give the impression of a simultaneous execution of several processes. In an embodiment, for reasons of security and reliability, an operating system can prevent direct communication between independent processes, providing a strictly mediated and controlled inter-process communication function.

1. Method for detecting a moving body close to a structure, which comprises:
a step of capturing a video stream representative of an environment around the structure;
a step of decomposing the video stream, by a computational device, into an initial sequence of at least two successive images;
a step of subtracting, by a computational device, a first image and a second image from the initial sequence;
a step of detecting, by a computational device, a movement which is representative of a presence of a moving body as a function of the subtraction performed;
a step of defining, by a computational device, coordinates which are representative of a search window of the moving body as a function of coordinates of the movement detected;
a step of constituting, by a computational device, a sequence of truncated images by selecting, in the initial sequence of images, an area of the images which are restricted to the search window; and
a step of processing, by means of a trained neural network, the sequence of truncated images in order to recognise a moving body in the sequence of images.

2. Method according to claim 1, which also comprises, when the structure comprises a moving portion, a step (190) of emitting a command stopping the moving portion when a moving body is detected.

3. Method according to claim 1, wherein the moving body is an animal.

4. Method according to claim 1, which comprises:
a step of the time integration, by a computational device, of results from the processing step;
a step of detecting, in the integrated results, a pattern representative of a risk of collision between the moving body and the moving portion.

5. Method according to claim 4, wherein the step of emitting a command stopping the moving portion is performed as a function of the pattern detected.

6. Method according to claim 1, which comprises a step of emitting an audible and/or visible warning as a function of the pattern detected.

7. Method according to claim 1, which comprises after the subtraction step, a step (130) of thresholding applied to the result of the subtraction step.

8. Method according to claim 7, which comprises after the thresholding step, a step (135) of erosion applied to the result of the thresholding step.

9. Method according to claim 8, which comprises after the erosion step, a step of dilation applied to the result of the erosion step.

10. Method according to claim 9, which comprises after the dilation step, a step of segmentation applied to the result of the dilation step.

11. Method according to claim 1, wherein the network is a convolutional neural network.

12. Device for detecting a moving body close to a structure, which comprises:
means for capturing a video stream representative of an environment around the structure;
means for decomposing the video stream into an initial sequence of at least two successive images;
means for subtracting a first image and a second image from the initial sequence;
means for detecting a movement which is representative of a the presence of a moving body as a function of the subtraction performed;
means for defining coordinates which are representative of a search window of the moving body as a function of coordinates of the movement detected;
means for constituting a sequence of truncated images by selecting, in the initial sequence of images, an area of the images which are restricted to the search window; and
means for processing, by means of a trained neural network, the sequence of truncated images in order to recognise a moving body in the sequence of images.

13. Device according to claim 12, which also comprises, when the structure comprises a moving portion, means for emitting a command stopping the moving portion when a moving body is detected.
